(19) United States
(12) Patent Application Publication
(10) Pub. No.: US 2017/0337596 A1
(43) Pub. Date: Nov. 23, 2017

(54) SYSTEMS AND METHODS FOR GENERATING A BUSINESS REVIEW ASSESSEMENT SCORE VIA AN ONLINE WEBSITE

(71) Applicant: Steven E. Larkin, Monrovia, CA (US)

(72) Inventor: Steven E. Larkin, Monrovia, CA (US)

(21) Appl. No.: 15/599,179

(22) Filed: May 18, 2017

Related U.S. Application Data
(60) Provisional application No. 62/338,217, filed on May 18, 2016.

(51) Int. Cl. G06Q 30/02; G06F 7/08

(52) U.S. Cl. CPC G06Q 30/0282; G06F 7/08

(57) ABSTRACT

Various aspects of the present disclosure relate to online business reputations and more specifically to systems and methods for providing, generating, analyzing, determining, reporting and modifying an accurate online reputation of a business in the form of an up to date business review assessment score for a business. The business review assessment score may be in the form a numeric value calculated at least in part on positive and negative reviews of the business, the overall number of online reviews of the business, the overall number of years in business and the overall review/credit sites associated with the business.

### CLAIM OF PRIORITY

The present application for patent claims priority to U.S. Provisional Application No. 62/338,217 entitled “Systems and Methods for Generating a Business Review Assessment Score”, filed May 18, 2016, which is hereby expressly incorporated by reference.

### FIELD

Various aspects of the present disclosure relate to online business reputations and more specifically to systems and methods for analyzing, determining, reporting and modifying an online reputation of a business, professional or individual, for example. The online reputation of a business, professional or individual is comprised of a business review assessment score generated from positive and negative online information dynamically generated by a computer terminal.

### BACKGROUND

The growth and success of a business is becoming more and more dependent on e-commerce, online transactions and online presences. This is in large part as consumers, and the world in general, require businesses to have an online presence. Even where businesses, professionals and individuals have their own online identity, these identities are augmented by an always growing portfolio of data surrounding the identities. As Internet users continue to spend more time with social media sites than any other type of site, each transaction, purchase, interaction with customer support or other event is likely to be noted, most likely permanently, in social media.

All these various social media cites can include business ratings, businesses rankings, and comments on transactions and experiences consumers have had with the businesses. All this information is viewable to potential consumers and clients of the business, or anyone else who has access to the Internet. Once posted, both positive and negative comments become a permanent fixture of that business on the Internet.

Currently, there is no way for a business or a consumer to obtain a business review assessment score that is generated from all the positive and negative online information from multiple social media sources. The business or consumer must review potentially hundreds or thousands of social media sites and web pages looking through reviews and comments to establish a general idea or an overview of a particular business. Not only is this time consuming and inaccurate, it is also impractical. Furthermore, some of the more relevant or trending results may be harder to find leaving the consumer with an inaccurate assessment of a business, either for better or worse.

Consumers may not realize that a business has listened to its consumers and improved its customer service and instead believe old reviews. If the latest or trending information shows significantly improved ratings over the past few weeks or months or years, a customer may be more inclined to conduct business with that business.

Additionally, as there is currently no system or method to identify the current online reputation of a business so businesses cannot identify areas that need improvement. Without being able to identify the weaknesses in a business's online reputation, it is nearly impossible to make a focused and effective effort to improve the overall online reputation of the business.

Therefore, there is a need for a system and method for generating and providing an accurate and up to date business review assessment score for a business.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one feature, a computer implemented method for initiating a business review assessment score via an online website. The method includes receiving, by a computing terminal comprising one or more processors, one or more memory devices and a user interface, an electronic input from a user; responsive to receiving the electronic input, accessing a communication network, by the computing terminal, to search for a plurality of data sources related to the electronic input; transmitting, to an application server, the plurality of data sources identified in the search of the communication network for analysis; dynamically sorting, by the application server, the plurality of data sources into one or more groups of data sources; assigning, by the application server, weighted values to each group in the one or more groups of data sources; dynamically calculating, by the application server, the assessment score based on the each weighted value assigned to the each group in the one or more groups of data sources; and in response to calculating the assessment score, generating and providing a splash page configured to display the assessment score and the plurality of data sources on the computing terminal for the user.

According to one aspect, the electronic input is a request from a consumer for information related to a business.

According to one aspect, the electronic inputs is a request from the user for information related to a type of business in a specific geographical location.

According to one aspect, the method further comprises transmitting, to a database, the plurality of data sources identified in the search of the communication network for storage and dynamically identifying, at the application server, one or more weaknesses in the business assessment score of a business.

According to one aspect, the application server transmits the one or more identified weaknesses to the business. The one or more weaknesses are based on the plurality of data sources.

According to one aspect, the method further comprises providing, by the application server, a listing of online review sites, websites and creditors utilized to generate the business review assessment score, where the listing is displayed on the computing terminal.

According to one aspect, the plurality of data sources includes at least one of positive and negative online reviews, an overall number of online reviews, an overall number of years a business has been in operation; and an overall number credit sites associated with the business.

According to one aspect, the user pre-determines which of the plurality of data sources is most important.

According to another feature, a computer implemented method for initiating a business review assessment score via an online website is provided. The method includes receiving, by a computing terminal comprising one or more processors, one or more memory devices and a user interface, an electronic input from a user; responsive to receiving the electronic input, accessing a communication network, by the computing terminal, to search for a plurality of data sources related to the electronic input; transmitting, to an application server, the plurality of data sources identified in the search of the communication network for analysis; dynamically sorting, by the application server, the plurality of data sources into one or more groups of data sources; assigning, by the application server, weighted values to each group in the one or more groups of data sources; dynamically calculating, by the application server, the assessment score based on the each weighted value assigned to the each group in the one or more groups of data sources; in response to calculating the assessment score, generating and providing a first splash page configured to display the assessment score and the plurality of data sources on the computing terminal for the user; dynamically identifying, at the application server, one or more weaknesses in the business assessment score of a business; and transmitting, by the application server to the business one or more weaknesses identified when calculating the business assessment score of the business

According to one aspect, the electronic input is a request from the user for information related to a specific business.

According to one aspect, the electronic input is a request from the user for information related to a type of business in a specific geographical location.

According to one aspect, the method further comprises comprising transmitting, to a database, the plurality of data sources identified in the search of the communication network for storage.

According to one aspect, wherein the one or more weaknesses are based on the plurality of data sources identified in the search.

According to one aspect, the method further comprises providing, by the application server, a listing of online review sites, websites and creditors utilized to generate the business review assessment score, where the listing is displayed on the computing terminal.

According to one aspect, wherein the plurality of data sources includes at least one of positive and negative online reviews, an overall number of online reviews, an overall number of years a business has been in operation; and an overall number credit sites associated with the business.

According to one aspect, wherein the user pre-determines which of the plurality of data sources is most important.

### BRIEF DESCRIPTION OF THE DRAWINGS

FIG. 1 is a block diagram illustrating the internal functional architecture of a computer system usable with one or more aspects of the systems and methods of the present disclosure.

FIG. 2 is a schematic of a system in accordance with an embodiment of the present disclosure.

FIG. 3 is a flow chart illustrating a method of searching for a business review assessment score, according the present disclosure.

FIG. 4 is an exemplary search request display screen on a computing terminal.

FIG. 5 is an example of a splash screen showing the assessment score on the computing terminal.

FIG. 6 is a flow chart illustrating a method of generating a business review assessment score, according to the present disclosure.

FIG. 7 is a flow chart illustrating a method of a business generating an online profile, according to the present disclosure.

FIG. 8 is a flow chart illustrated a computer implemented method for initiating a business review assessment score via an online website.

FIG. 9 is an example of a splash screen displaying a business assessment score on a computing terminal.

FIG. 10 is a diagram illustrating an example of a hardware implementation for a system configured to generate a business review assessment score for a particular business.

### DETAILED DESCRIPTION

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, the term “embodiments” does not require that all embodiments include the discussed feature, advantage or mode of operation.

The term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The term “business” may refer to a business entity, a professional, a group of professionals, an individual or a group of individuals. The term “data sources” may refer to online reviews, information on websites, review sites, creditor information, number of years in business, number of reviews, number of recommendations or any other type of data that may be found online about a business. The term “electronic input” may refer to the name of a business, the type of a business, the geographical location of a type of business or any other information that may be used to identifying a business. The term “user” may refer to a consumer, an individual, a business, a groups of consumers, a group of individuals or anyone or any entity seeking information on a business.

Various aspects are described herein in connection with a computer or a terminal, which can be a wired terminal (wired computer) or a wireless terminal (wireless computer). The term “computer”, “terminal” or “computer terminal” may refer to any device or devices having at least one processing element and capable of carrying out a set of instructions such as arithmetic or logical operations. As used herein, the terms “computer”, “terminal” or “computer terminal” may also be called, for example, a system, device, subscriber unit, subscriber station, mobile station, mobile, mobile device, remote station, remote terminal, access terminal, user terminal, communication device, user agent, user device, user equipment (UE), a Personal Computer (PC), a mobile computer, a laptop computer, a handheld computer, a notebook computer, a tablet computer, a wireless device, a mobile phone, a mobile communication device, a user communication device, personal digital assistant, mobile palm-held computer, a workstation, and/or a server.

### Overview

Various aspects of the present disclosure relate to a computer implemented systems and methods for generating an assessment score for a business. The systems and methods of the present disclosure dynamically generate an assessment score for a business using online business reviews and online business reputations. More specifically, the present disclosure is directed to systems and methods for dynamically providing, generating, analyzing, determining, reporting and modifying an accurate online reputation of a business in the form of an up to date business review assessment score for a business. The business review assessment score may be in the form a numeric value dynamically generated or calculated by a computing terminal at least in part on on-line positive and negative reviews of the business, the overall number of online reviews of the business, the overall number of years in business and the overall review/credit sites associated with the business identified by the computing terminal's search of the network.

According to an embodiment, the overall positive and negative reviews may comprise 60% of the score, the overall number of online reviews of the business may comprise 10% of the score, the overall years in business may comprise 15% of the score and the overall review/credit cites associated with the business may comprise 15% of the score. These percentages are by way of example only and the percentages may be allocated differently. The business review assessment score may be utilized by consumers in determining which business to utilize or patronize.

The business review assessment score as described herein may be used to rate every businesses online presence in the world and may be used as the benchmark standard for all reputable businesses. Businesses that do not have a business review assessment score or have a score that is low may lose business as consumers may be hesitant to do business with them.

Additionally, any person or business in the world will have the ability to enter a business name into a website such as www.cobrascore.com to obtain a business review assessment score that was dynamically generated by custom algorithms to determine a score that represents the overall businesses online reputation. The consumer or searcher will then have the ability to see the plurality of data sources that was used to calculate the score to obtain a more in depth look at the business. The business owner will also have the ability to see where the business is thriving or lacking to help improve their overall score. The business owner will also be able to enter specific business information for someone looking for a business with specific offerings.

When dynamically generating/determining/calculating the score, a computing terminal may connect with a communication network, such as the Internet, to extract or search for a plurality of data sources which may be sent to an application server for analysis. The application server may sort the plurality of data sources into one or more similar groups of data sources. As defined above, data sources can include, but are not limited to, online reviews, information on websites, review sites, creditor information, number of years in business, number of reviews, number of recommendations or any other type of data that may be found online about a business. Each group in the one or more groups of data sources may be assigned a weighted value based on the algorithm provided to the application server. As described in more detail below, different sources of data may have more weight in determining the assessment score for the business. According to one embodiment, the assessment score is associated with the entire online profile of the business.

According to one embodiment, a consumer, or other individual, may enter electronic input into a website on a computing terminal, such as a business name. In one example, the business name may be entered into a search bar on a display screen of a website on the computing terminal and the computing terminal immediately connects with a communication network, such as the Internet, and begins searching the Internet and dynamically extracting or identifying any relevant data sources. Once the data sources have been identified, the data sources are provided to the server which may dynamically sort the data sources into one or more groups and provide each group with a weighted value. The weighted values are used by the algorithm programmed into the server to generate/determine/calculate the assessment score as explained in more detail below. In response to calculating the assessment score, a splash screen configured to display the assessment score is generated and provided to the computing terminal to display the assessment score and the plurality of data sources for the user.

According to one example, the sources for the score may be provided to the individual in the form of a list. The list may provide the creditability of each source and may list the sources in order of credibility. The searched business websites may also be available if a consumer decides to conduct business or transactions with that business. Detailed information regarding the business and the services they offer will also be available if the business has been claimed by the business owner. That is, the owner of the business has acknowledged the data sources or information relates to his or her business.

The website and algorithm described herein may be utilized to dynamically generate a business review assessment score, based on identifying a plurality of data sources, for providing a consumer with an accurate online reputation of a business. At least in one embodiment, the website and algorithm are not utilized by a consumer for reviewing a business.

### Computing Terminal

Aspects of the systems and methods described below may be operable on any type of general purpose computer system or computing terminal, including, but not limited to, a desktop and a mobile device. The term “mobile device” includes, but is not limited to, a wireless device, a mobile phone, a mobile communication device, a user communication device, personal digital assistant, mobile palm-held computer, a laptop computer, an electronic book reader and reading devices capable of reading electronic contents and/or other types of mobile devices typically carried by individuals and/or having some form of communication capabilities (e.g., wireless, infrared, short-range radio, etc.).

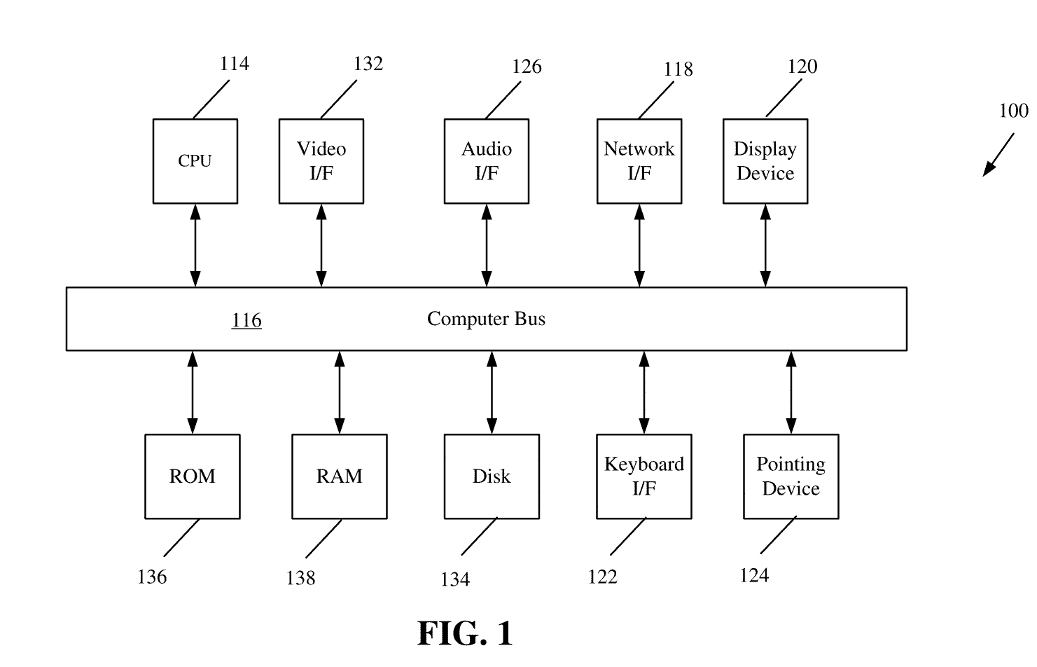

FIG. 1 is a block diagram illustrating the internal functional architecture of a computer system 100 usable with one or more aspects of the systems and methods described in further detail below. As shown in FIG. 1, the computer system 100 may include a central processing unit (CPU) 114 for executing computer-executable process steps and interfaces with a computer bus 116. Also shown in FIG. 1 are a network interface 118, a display device interface 120, a keyboard or input interface 122, a pointing device interface 124, an audio interface 126, a video interface 132, and a hard disk drive 134.

As described above, the disk 134 may store operating system program files, application program files, web browsers, and other files. Some of these files may be stored on the disk 134 using an installation program. For example, the CPU 114 may execute computer-executable process steps of an installation program so that the CPU 114 can properly execute the application program.

A random access main memory (“RAM”) 136 may also interface to the computer bus 116 to provide the CPU 114 with access to memory storage. When executing stored computer-executable process steps from the disk 134, the CPU 114 stores and executes the process steps out of the RAM 136.

Read only memory (“ROM”) 138 may be provided to store invariant instruction sequences such as start-up instruction sequences or basic input/output operating system (BIOS) sequences for operation of the keyboard 122.

System

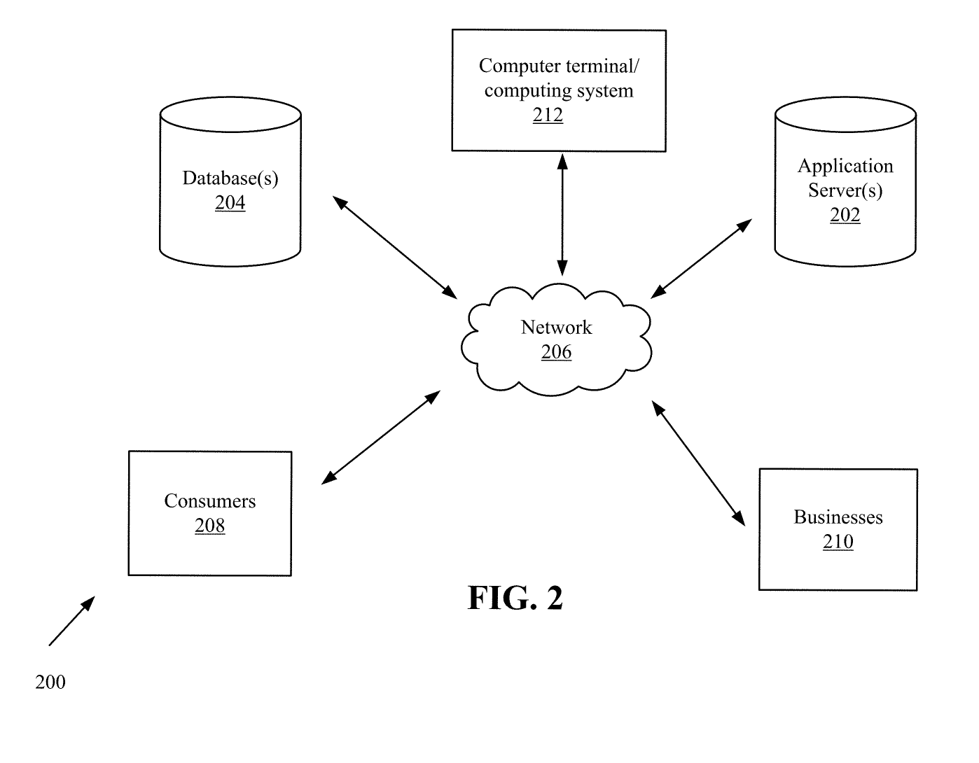

FIG. 2 is a schematic of a system 200 in accordance with an embodiment of the present disclosure. The system 200 may include of one or more application servers 202 for electronically receiving, processing, and storing data sources or information calculated or generated by the data sources, such as an assessment scores, used by the system. Modules and circuits in the server 202 may retrieve and manipulate information in storage devices 204, such as databases, and exchange information through a network 206, such as the Internet.

The users (or consumers/individuals) 208 and businesses 210, using a computing terminal or computing system 212 may be coupled to a network 206, such as the Internet, through which it communicates with the server 202 to obtain a plurality of data sources which may be used to dynamically generate or calculate the business review assessment score. As described in more detail below, the user (or consumer/individual) 208 may provide an electronic input into the computing terminal 212. The electronic input may include, but is not limited to, the name of a business and the type of business and a geographical area. Responsive to the electronic input, the computing terminal 212 may then connect to the Internet 206 dynamically search for a plurality of data sources associated with the electronic input. The plurality of data may include, but is not limited to, websites related to the business, number of years a particular business has been active (or in business), reviews of the business (both positive and negative), and/or creditors. The plurality of data sources, which provide information that can be used to identify, determine, or generate data related to the business and/or the current online reputation of the business being searched, may be sorted into one or more groups. According to one embodiment, each of the groups may be assigned a weighted value that is used in determining the assessment score.

The electronic input may also include a type of business in a geographical location. Any data or data sources retrieved from the Internet may be stored in a database 204 as well as sent to the application server 202. The computing terminal 212 may search the communication network for data sources related to a particular business or a type of business in a particular geographical location. The located data sources may be transmitted and stored on the database 204 as well as the application server 202. According to one embodiment, the application server 202 may sort the data sources into one or more groups and assign weighted values to each group in the group of data sources. The data sources and weighted valued may be used to generate/determine/calculate the business review assessment score for the user. This score may then be displayed on a splash screen (or other screen) on the computing terminal 212 for the user to see. The business review assessment score may also be stored in the database 204.

As indicated previously, the business review assessment score may take into consideration both positive and negative information (data sources) and reviews of the business. Negative information and reviews will lower the score while a good track record or positive reviews will raise the score. The information or data sources may be extracted from various online review sites, websites and creditors including, but not limited to Yelp®, Google®, Yahoo®, Angie's List®, Facebook®, Foursquare®, Goodsnitch®, Manta®, Merchant Circle®, Surecritic®, Twitter®, Bing®, City Search®, Local.com®, Insiderpages, Judys Book®, Trip Advisor®, Open Table®, Better Business Bureau® (BBB), Buzzillions®, Epinions®, Wize®, Power Reviews®, Sitejabber, Amazon®, Consumer Reports®, Demand Force®, Dex Knows®, DoneRight®, Home Advisor®, Yellow Pages® and Dunn & Bradstreet®.

Searching for a Business Review Assessment Score

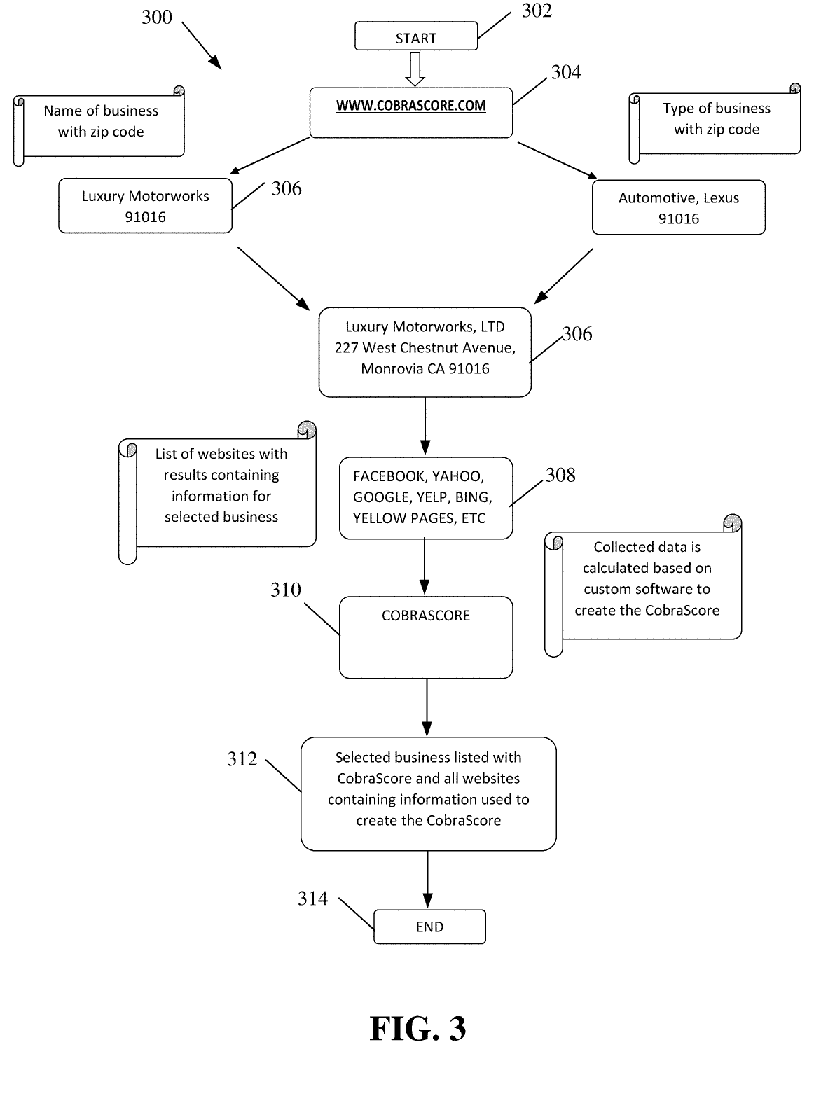

FIG. 3 is a flow chart illustrating a method 300 of searching for a business review assessment score, according the present disclosure. First, a consumer begins a search 302 by logging onto a website 304, such as www.cobrascore.com, on a computing terminal and entering an electronic input in the form of search criteria. In one embodiment, the consumer may search for a particular business name 306 by entering the name of the business and some geographical identifier such as a zip code or city and state. The system may search its database of profiles of a communication network, such as the Internet, to locate a business 306 that most matches the search criteria. Once the business has been selected by the consumer as the business for which the score is sought, a list of websites with results containing information and data for the selected business is gathered 308. The websites may include, but are not limited to, Facebook®, Yahoo®, Google®, Yelp®, Bing® and Yellow Pages®. The data identified and collected on these websites may then be used to calculate or generate the business review assessment score 310 that the consumer is seeking, as described below. Next, the selected business is displayed for the consumer to review along with the calculated score and the websites containing information and/or data used to create the score 312 and the process is completed 314.

According to another embodiment, the consumer may search for a type of business 307 by entering the type of the business and some geographical identifier such as a zip code or city and state. For example, the consumer may be searching for Lexus® dealers in the zip code 91016. The system will search its database of profiles, or a communication network, such as the Internet, to locate the specific type of business 306 that the consumer is looking for and in the geographical area identified by the consumer. A list of businesses that meet the consumer's criteria will be generated for review by the consumer. The consumer may then select a particular business for review. Once the business has been selected by the consumer, a list of websites with results containing information and data for the selected business is gathered 308. The websites may include, but are not limited to, Facebook, Yahoo, Google®, Yelp®, Bing® and Yellow Pages®. The data (or data sources) identified and collected on these websites may then be used to calculate or generate the business review assessment score 310 that the consumer is seeking. Next, the selected business is displayed via a splash screen on the computing terminal for the consumer to review along with the calculated score and the websites containing information and/or data used to create the score 312 and the process is completed 314.

Display Screens

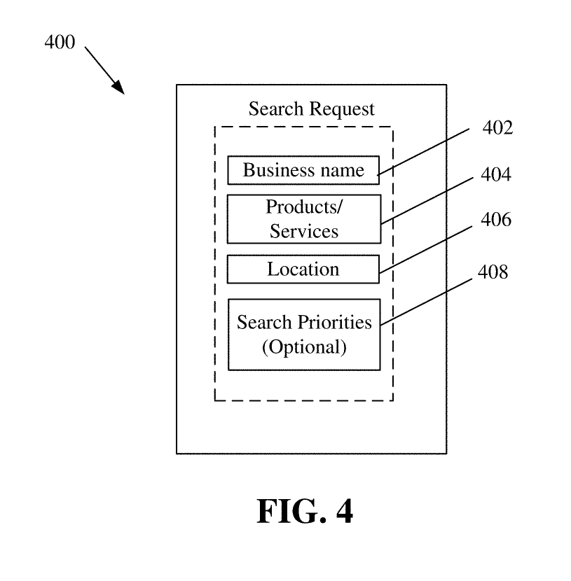

FIG. 4 is an exemplary search request display screen 400 on a computing terminal. As shown, the consumer can search for, including but not limited to, scores of businesses by the name of the business 402, the products and/or services offered by businesses 404 and the location of the business 406.

Optionally, the consumer may customize search priorities 408 when the business review assessment score is calculated. As described in more detail below, the business review assessment score may be calculated utilizing many different pieces of online data sources from a business profile. A pre-determined algorithm may be used to calculate the score. For example, the business review assessment score may be based on (1) 60% of the score based on positive and negative reviews; (2) 10% of the score based on number of reviews; (3) 15% of the score based on length of history or the number of years in business; and (4) 15% of the score based on the number of review/credit sites. However, in accordance with another embodiment, algorithm may allocate the data sources different. For example, each data source by be assigned a weighted value by the application server based on the reliability of the data source and/or the amount of data provided by the data source. In another example, the consumer may optionally select which data sources to provide more weight too based on which data source is most important to the consumer. For example, the consumer may want 15% of the business review assessment score to be based on the number of reviews and only 10% of the business review assessment score to be based on the number of review/credit sites.

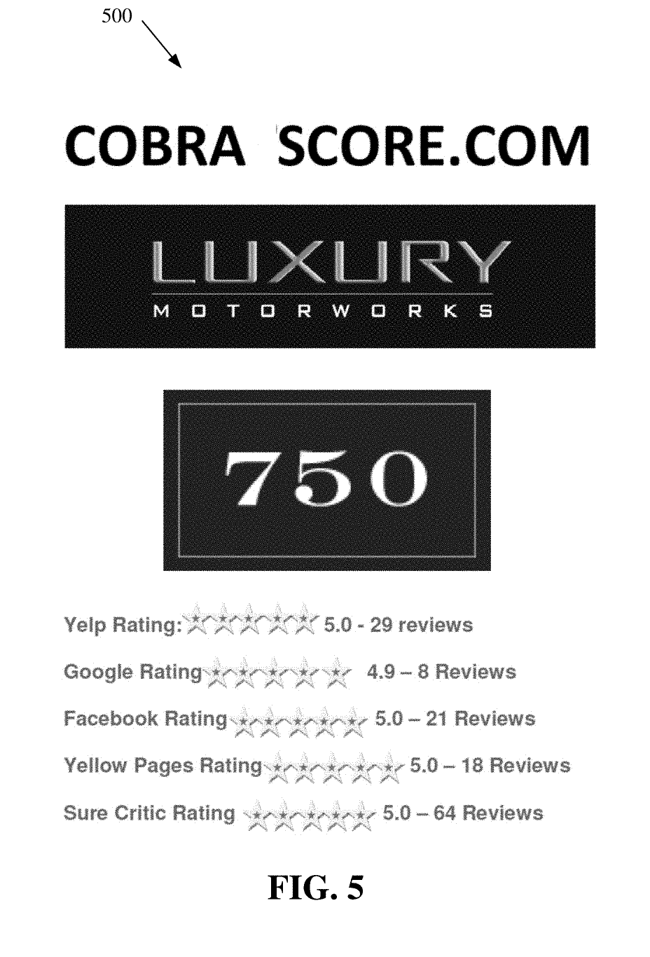

FIG. 5 is an example of a splash screen showing the assessment score on the computing terminal. As shown, the splash screen 500 shows the consumer has selected Luxury Motorworks as the business for which to see the business review assessment score and a score of 750 has been calculated. The business review assessment score was calculated using information and data obtained from Yelp®, Google®, Facebook®, Yellow Pages® and Sure Critic®. The consumer is able to see the number of ratings on each website as well as the number of reviews that have been posted to each website.

Generating/Calculating a Business Review Assessment Score

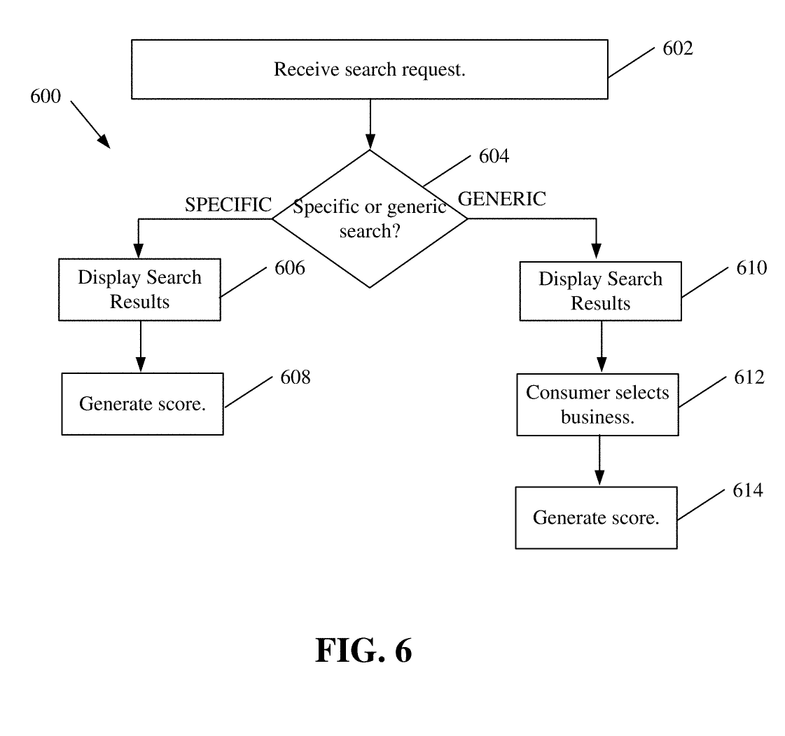

FIG. 6 is a flow chart illustrating a method 600 of generating a business review assessment score, according to the present disclosure. First, a search request may be received at a computing terminal from a consumer 602. A determination is then made if the search request is a search for a specific business or a generic search looking for a particular type of business in a specific geographical location 604. In either instance, the computing terminal may search its database for any pre-stored scores or may connect to a communication network, such as the Internet, to identify data sources related to the search criteria.

If the search request is for a specific business, the consumer may enter the name of a specific business along with geographical information of the business, such as a zip code. The system may then then search its database of profiles as well as the Internet to locate a business that most matches the search criteria and displays a list of websites with results containing information and data sources for the selected business 606. As described previously, the websites may include, but are not limited to, Facebook®, Yahoo®, Google®, Yelp®, Bing® and Yellow Pages®. The list of websites may be displayed on the computing terminal in order or relevance with links to each website so that the consumer can further research the business. The data identified and collected on these websites may then be used to calculate or generate the business review assessment score 608 which is then provided to the consumer. Optionally, the consumer may be supplied with the online profile of the business stored in the system. FIG. 5 provides a listing of websites that the consumer may see.

If the search request is for a particular type of business in a specific geographical area, the system will search its database of profiles for businesses, or the Internet, that most closely identifies with the search criteria and displays a list of possible businesses for the consumer to review 610. After reviewing the list, the consumer may selects 612 the business for which to see the business review assessment score which is then generated and displayed to the consumer 614.

If the consumer searches for a specific business that has not been claimed, the business review assessment score will be generated from a plurality of data sources identified in the search by the computing terminal provided with the itemized results from Yelp®, Yahoo®, Google®, etc. but without the business online profile of the business. According to one embodiment, the consumer may have the option to click on a link that says “Business has not been claimed, let the business know by clicking here”. If the consumer clicks on the link an e-mail may be sent to the business to let the business know a consumer has been interested in finding out more information regarding their business.

Business Generating a Profile

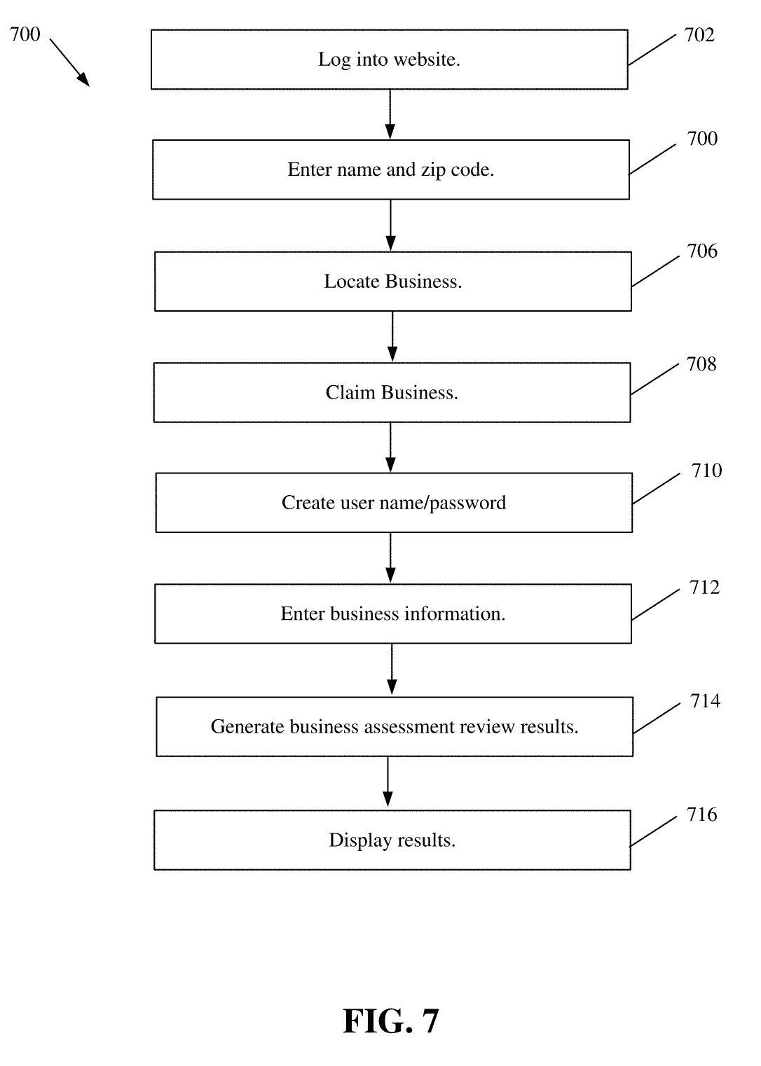

FIG. 7 is a flow chart illustrating a method 700 of a business generating an online profile, according to the present disclosure. First, a business may log onto a website, such as www.cobrascore.com, using a computing terminal and click on the business review assessment score link 702. The link may lead the business owner to a screen requesting the name and geographical information of the business 704. The geographical information can include the zip code and/or the city and state. Using this information, the system may locate the business or businesses that most closely match the search criteria 706. If the business owner does not see his business, he may manually enter his business information into the system to generate a business profile. The business owner may then claim the business as their own 708 by entering or creating a unique username and password associated with the unsername 710. Once a unique username and password have been created, the business owner may fill out information related to the business, such as the types of products and services offered, the number of years in business, add photographs associated with the business, etc. 712. Next, the business owner may select a link to generate the business review assessment results of the business 714. The overall business review assessment results may then be displayed in a large numeric form on the computing terminal of the business owner 716. The itemized results from Yelp®, Yahoo®, Google®, etc. may be displayed on the bottom of the page with links to each website for more specific information so that the business owner can evaluate comments, both positive and negative, provided by consumers.

According to one example, the application server may identify weaknesses in a business's online reputation based on the plurality of data sources and inform the business of the identified weakness. For example, the application server may automatically determine that the business has only a minimal amount of online review compared to the number of years it has been in business. As such, the application server may indicate to the business that its online presence needs to be increased.

Method for Initiating a Business Review Assessment Score via an Online Website

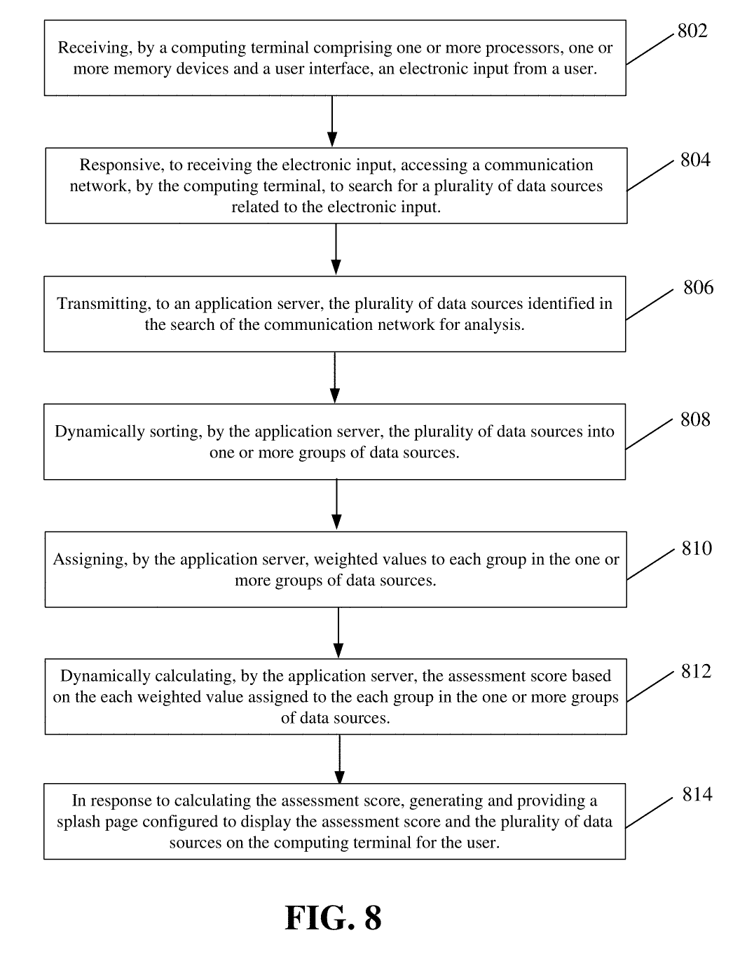

FIG. 8 is a flow chart illustrated a computer implemented method for initiating a business review assessment score via an online website. First, the computing terminal, comprising one or more memory devices and a user interface, may receive an electronic input from a user 802. Responsive to receiving the electronic input, the computing terminal may access a communication network, such as the Internet, to search for a plurality of data sources related to the electronic input 804. Once a plurality of data sources have been identified, the plurality of data sources may be transmitted to an application server for analysis 806. In one embodiment, the plurality of data sources may also be transmitted to a database for storage and later retrieval.

The application server may then dynamically sort the plurality of data sources into one or more groups of data sources 808. Next, based on a pre-determined algorithm in the application server, the application server may assign weighted values to each group in the one or more groups of data sources 810. For example, the number of years in business may hold more weight than the number of reviews that have been received on a particular website. In such a case, the number of years in business may be more important in generating the business assessment score. In one embodiment, the user may be allowed to allocate which data sources should hold more weight when calculating the business assessment score.

After the plurality of data sources have been sorted and assigned weighted values, the application server may dynamically calculate/determine/generate the business assessment score based on the weight value assigned to each group in the one or more groups of data sources 812. In response to calculating the assessment score, the application server may generate and provide a splash screen to the computing terminal to display the assessment score and the plurality of data sources for the user 814.

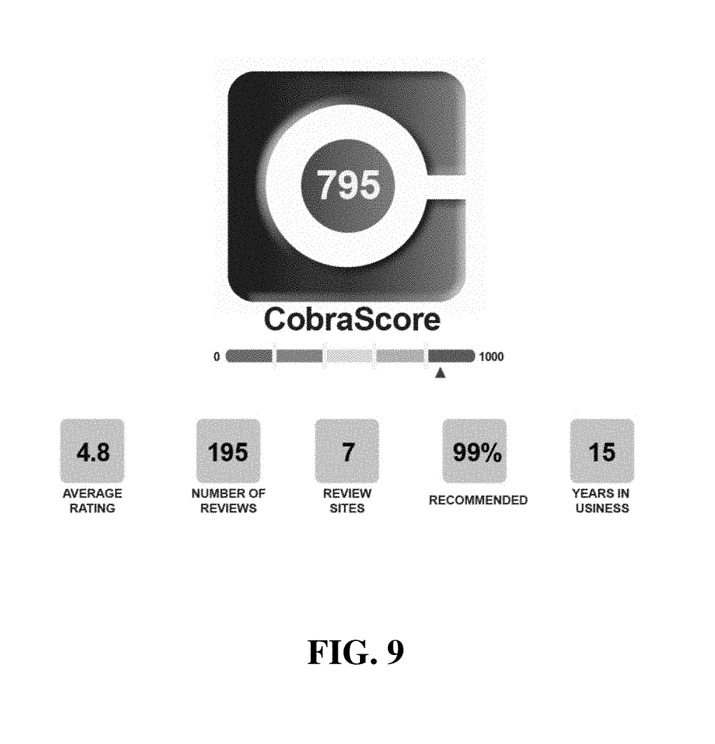

FIG. 9 is an example of a splash screen displaying a business assessment score on a computing terminal. As can be seen, the business assessment score is 795 out of 1000, the average rating by each user is 4.8, the number of reviews is 195, the review sites considered in determining the score is 7, 99% of the online users who rated this business recommend it and the business has been in business for 15 years.

Mobile Computing Terminal

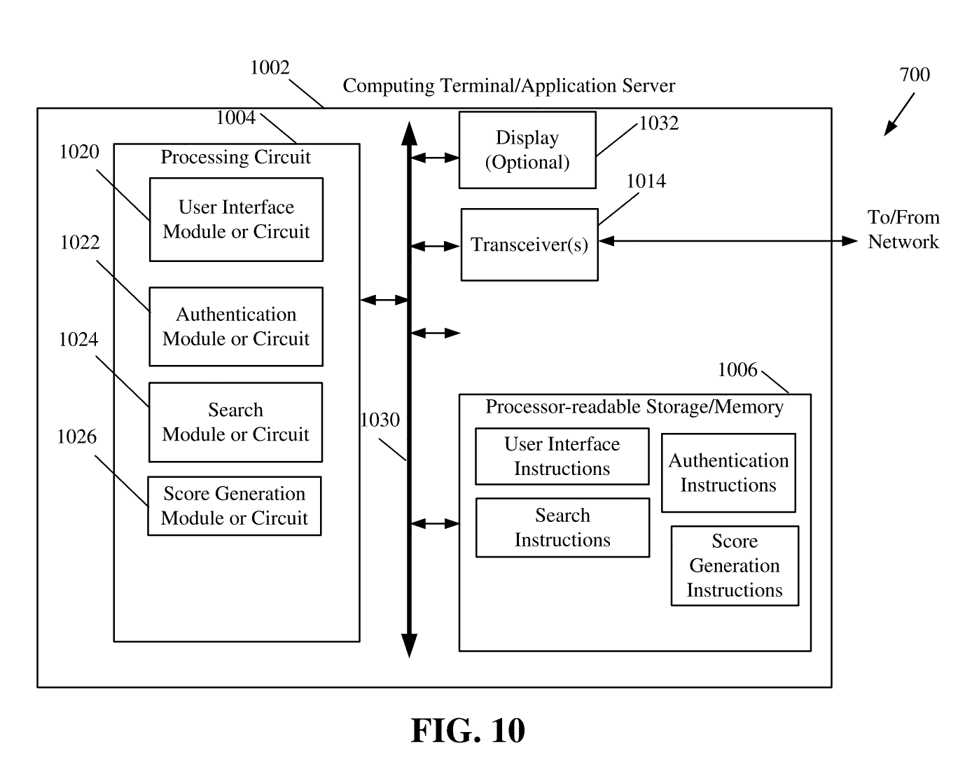

FIG. 10 is a diagram illustrating an example of a hardware implementation for a mobile computing terminal and/or an application server configured to generate a business review assessment score for a particular business. The mobile computing terminal 1002 may include a processing circuit 1004. The processing circuit 1004 may be implemented with a bus architecture, represented generally by the bus 1030. The bus 1030 may include any number of interconnecting buses and bridges depending on the application and attributes of the processing circuit 1004 and overall design constraints. The bus 1030 may link together various circuits including one or more processors and/or hardware modules, processing circuit 1004, and the processor-readable medium 1006. The bus 1030 may also link various other circuits such as timing sources, peripherals, and power management circuits, which are well known in the art, and therefore, will not be described any further.

The processing circuit 1004 may be coupled to one or more communications interfaces or transceivers 1014 which may be used for communications (receiving and transmitting data) with entities of a network or system.

The processing circuit 1004 may include one or more processors responsible for general processing, including the execution of software stored on the processor-readable medium 1006. For example, the processing circuit 1004 may include one or more processors deployed in the mobile computing terminal 212 and/or the application server 202 of FIG. 2. The software, when executed by the one or more processors, cause the processing circuit 1004 to perform the various functions described supra for any particular computing terminal and/or application server. The processor-readable medium 1006 may also be used for storing data that is manipulated by the processing circuit 1004 when executing software. The processing system further includes at least one of the modules 1020, 1022, 1024 and 1026. The modules 1020, 1022, 1024 and 1026 may be software modules running on the processing circuit 1004, resident/stored in the processor-readable medium 1006, one or more hardware modules coupled to the processing circuit 1004, or some combination thereof.

In one configuration, the mobile computing terminal and/or application server 1002 for wireless communication includes a module or circuit 1020 configured to receive search requests from a consumer or business owner interacting with the mobile computing terminal and/or application server 1002, a module or circuit 1022 configured to authenticate the consumer or business owner requesting the business review assessment score, a module or circuit 1024 configured search a database or other storage device for a profile that most closely matches the search criteria, and a module or circuit 1026 configured to generate or calculate the business review assessment score of the business using overall positive and negative reviews of the business, the overall number of reviews, the overall years in business and the overall review/credit sites associated with business as identified from various websites including social media sites. The module of circuit 1026 may also sort the plurality of data sources into one or more groups and assigned weighted values to the one or more groups.

In one configuration, the computing terminal and/or application server 1002 may include a display or touch screen 1032 for receiving and displaying data to the consumer.

Moreover, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Monetization

The system and method of the present disclosure may assist with the monetization of a business, in other words generate income. For example, when a consumer goes to the website, such as cobrascore.com, to locate a business with positive reviews or ratings, advertisers may appear according to the nearest zip code of the searching device. If the business is not an advertiser all advertising businesses will be listed first. Consumers will be able to search by a specific business name and zip code or category, such as auto, plumber, roofer, tile layer, etc. Results will then be displayed with the overall score in order from nearest to furthest from the searching device.

Businesses can also pay for a minimal service which will give the business back end management to: (1) alerts if their score has been modified, (2) alerts for how many people checked business profile, and (3) alerts for how many people called the telephone number of the business. Businesses can also pay for advertisement which will put them top of the list of searches.

Benefits to Consumers

The system and method of the present disclosure provide consumers with a single location to obtain a complete profile of one business, provide the consumer with peace of mind with a specific business and force all businesses to maintain good business credibility.

Benefits to Businesses

The system and method of the present disclosure provide businesses with an overall rating of the businesses complete online presence without relying on one website, notification if a consumer leaves a review on any of the websites, provides a place to showcase the business and its services, and provides a vehicle to allocate advertising dollars in a reputable non biased well-traveled website.

### EXAMPLE

The business review assessment scores described herein may be calculated from many different pieces of online data from a business profile, i.e. the plurality of data sources. According to one example, the plurality of data sources may be grouped into four categories as outlined below. The percentages may correspond to weighted values which reflect how important each of the categories is in determining how the business review assessment scores are calculated.

The business review assessment score may take into consideration both positive and negative information in a business's online profile. Negative reviews will lower the score while establishing or re-establishing a good track record of positive reviews will raise the score.

An example of how a business review assessment score breaks down is shown below.

60% of the score is based on positive and negative reviews
Overall 5 star rating=600 points
Overall 4 star rating=500 points
Overall 3 star rating=250 points
Overall 2 star rating=100 points
Overall 1 star rating=0 points

10% of the score is based on number of reviews
500 reviews=100 points
250-499 reviews=75 points
100-249 reviews=50 points
10-99 reviews=25 points
1-9 reviews=10 points

15% of the score is based on length of history
21+ years=150 Points
11-20 years=100 Points
6-10 years=75 Points
3-5 years=50 Points
1-2 years=25 Points

15% of the score is based on the number of review/credit sites
10+ sites=150 Points
5-9 sites=100 Points
1-8 sites=50 Points
0 sites-0 Points

One or more of the components and functions illustrated the figures may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A computer implemented method for initiating a business review assessment score via an online website, comprising:
receiving, by a computing terminal comprising one or more processors, one or more memory devices and a user interface, an electronic input from a user;
responsive to receiving the electronic input, accessing a communication network, by the computing terminal, to search for a plurality of data sources related to the electronic input;
transmitting, to an application server, the plurality of data sources identified in the search of the communication network for analysis;
dynamically sorting, by the application server, the plurality of data sources into one or more groups of data sources;
assigning, by the application server, weighted values to each group in the one or more groups of data sources;
dynamically calculating, by the application server, the assessment score based on the each weighted value assigned to the each group in the one or more groups of data sources; and
in response to calculating the assessment score, generating and providing a splash page configured to display the assessment score and the plurality of data sources on the computing terminal for the user.

2. The method of claim 1, wherein the electronic input is a request from the user for information related to a specific business.

3. The method of claim 1, wherein the electronic input is a request from the user for information related to a type of business in a specific geographical location.

4. The method of claim 1, further comprising transmitting, to a database, the plurality of data sources identified in the search of the communication network for storage.

5. The method of claim 1, further comprising dynamically identifying, at the application server, one or more weaknesses in the business assessment score of a business.

6. The method of claim 5, further comprising, transmitting, by the application server, to the business the one or more weaknesses identified.

7. The method of claim 6, wherein the one or more weaknesses are based on the plurality of data sources.

8. The method of claim 1, further comprising providing, by the application server, a listing of online review sites, websites and creditors utilized to generate the business review assessment score, where the listing is displayed on the computing terminal.

9. The method of 1, wherein the plurality of data sources includes at least one of positive and negative online reviews, an overall number of online reviews, an overall number of years a business has been in operation; and an overall number credit sites associated with the business.

10. The method of claim 1, wherein the user pre-determines which of the plurality of data sources is most important.

11. A computer implemented method for initiating a business review assessment score via an online website, comprising:
receiving, by a computing terminal comprising one or more processors, one or more memory devices and a user interface, an electronic input from a user;
responsive to receiving the electronic input, accessing a communication network, by the computing terminal, to search for a plurality of data sources related to the electronic input;
transmitting, to an application server, the plurality of data sources identified in the search of the communication network for analysis;
dynamically sorting, by the application server, the plurality of data sources into one or more groups of data sources;
assigning, by the application server, weighted values to each group in the one or more groups of data sources;
dynamically calculating, by the application server, the assessment score based on the each weighted value assigned to the each group in the one or more groups of data sources;
in response to calculating the assessment score, generating and providing a first splash page configured to display the assessment score and the plurality of data sources on the computing terminal for the user;
dynamically identifying, at the application server, one or more weaknesses in the business assessment score of a business; and
transmitting, by the application server, to the business one or more weaknesses identified when calculating the business assessment score of the business

12. The method of claim 11, wherein the one or more weaknesses are based on the plurality of data sources identified in the search.

13. The method of claim 11, wherein the electronic input is a request from the user for information related to a specific business.

14. The method of claim 11, wherein the electronic input is a request from the user for information related to a type of business in a specific geographical location.

15. The method of claim 11, further comprising transmitting, to a database, the plurality of data sources identified in the search of the communication network for storage.

16. The method of claim 11, wherein the weighted values are associated with a percentage of the overall business assessment score.

17. The method of claim 11, further comprising providing, by the application server, a listing of online review sites, websites and creditors utilized to generate the business review assessment score, where the listing is displayed on the computing terminal.

18. The method of 11, wherein the plurality of data sources includes at least one of positive and negative online reviews, an overall number of online reviews, an overall number of years a business has been in operation; and an overall number credit sites associated with the business.

19. The method of claim 11, wherein the user pre-determines which of the plurality of data sources is most important.
